(19) United States
(12) Patent Application Publication
(10) Pub. No.: US 2005/0089642 A1
(43) Pub. Date: Apr. 28, 2005

(54) Dielectric materials preparation

(75) Inventors: Timothy G. Adams, Sudbury, MA (US); Hongshi Zhen, Worcester, MA (US); Gregory P. Prokopowicz, Lancaster, MA (US); Michael K. Gallagher, Hopkinton, MA (US)

Correspondence Address: S. Matthew Cairns;EDWARDS & ANGELL, LLP, P.O. Box 55874, Boston, MA, 02205, US

(73) Assignee: Rohm and Haas Electronic Materials, L.L.C., Marlborough, MA (US)

(21) Appl. No.: 10/976,292

(22) Filed: Oct. 27, 2004

Related U.S. Application Data
(60) Provisional application No. 60/515,169, filed on Oct. 28, 2003.

(51) Int. Cl. B05D 5/12; C07F 7/04

(52) U.S. Cl. 427/384; 556/467

(57) ABSTRACT

A method of preparing an organic polysilica partial condensate using basic and acidic catalysts is provided. Upon curing, such organic polysilica material has improved mechanical properties.

### BACKGROUND OF THE INVENTION

The present invention relates generally to the field of dielectric materials. In particular, the present invention relates to the field of dielectric materials having improved mechanical properties for use in electronic and optoelectronic device manufacture.

Silica has been widely used as an insulating material in various devices, such as integrated circuits, and as an optical material in certain devices, such as waveguides. One reason for the wide use of silica films is that they possess very good mechanical properties and can be processed using a variety of techniques and conditions. However, silica films have a dielectric constant of approximately 4, which makes then unsuitable for certain uses.

As electronic devices become smaller, there is a continuing desire in the electronics industry to increase the circuit density in electronic components, e.g., integrated circuits, circuit boards, multichip modules, chip test devices, and the like without degrading electrical performance, e.g., crosstalk or capacitive coupling, and also to increase the speed of signal propagation in these components. Such goals require interlayer, or intermetal, insulating material having reduced dielectric constants, i.e. <<4. A method for reducing the dielectric constant of such interlayer, or intermetal, insulating material is to incorporate within the insulating film very small, uniformly dispersed pores or voids. In the case of silica films, such pores reduce the dielectric constant to below 4, however, it is still not low enough for many electronics applications.

As an alternative to silica films, organic polysilica films, such as methylsilsesquioxane or phenylsilsesquioxane films, have been suggested. Organic polysilica films have a lower dielectric constant than silica films which makes them better as insulating materials for advanced electronics applications. However, the dielectric constant of organic polysilica films is not low enough for certain applications. As a result, porous organic polysilica films have been developed, e.g. see U.S. Pat. No. 6,271,273 (You et al.).

One drawback to the use of organic polysilica films is that their mechanical properties are not as good as those of silica films. For instance, organic polysilica films are not as hard as silica films, which presents challenges during certain manufacturing processes, such as planarization of layers in the manufacture of integrated circuits. By making such organic polysilica films porous, the mechanical properties of the films are further affected.

One approach to improving the mechanical properties of organic polysilica films is to use a composition of a silsesquioxane and a tetraalkoxysilane to form an insulating film. Such film has a higher cross-link density as compared to a silsesquioxane homopolymers and has enhanced mechanical properties, such as scratch resistance. A problem with this approach is that the tetraalkoxysilanes (which are themselves used to form silica films) increase the dielectric constant of these silsesquioxane films, making such films unsuitable for certain advanced electronics applications.

Porous organic polysilica films having low dielectric constants prepared from a silane monomer or a mixture of silane monomers are disclosed in European Patent Application 997 497 (Ioka et al.). The porous organic polysilica films are prepared by acid or base catalysis of the silane monomers. However, such films prepared from silane monomers having a carbon bridging moiety, i.e. monomers of the formula X₃Si—R—SiX₃, do not possess mechanical properties, such as modulus, equivalent to those of organic polysilica films prepared without such silane monomers.

There remains a need for organic polysilica films prepared from silane monomers having a carbon-containing bridging moiety having low dielectric constants and improved mechanical properties, such as modulus, for advanced electronic devices.

### SUMMARY OF THE INVENTION

The present invention provides a method of preparing an organic polysilica partial condensate including the steps of: a) reacting a composition including one or more silanes of the formula R¹_{b}(R²O)_{3-b}Si(R³)_{c}Si(OR⁴)_{3-d}R⁵_{d} in the presence of a hydrolysis catalyst; and then b) reacting the mixture in the presence of a condensation catalyst; wherein R¹, R², R⁴ and R⁵ are independently selected from hydrogen, (C₁-C₆)alkyl, (C₇-C₁₂)arylalkyl, substituted (C₇-C₁₂)aryl-alkyl, aryl, and substituted aryl; R³ is (C₁-C₁₀)alkylene, —(CH₂)ₕ—, —(CH₂)ₕ₁-Eₖ-(CH₂)ₕ₂—, —(CH₂)ₕ-Z, arylene, substituted arylene, or arylene ether; E is oxygen, NR⁶ or Z; Z is aryl or substituted aryl; R⁶ is hydrogen, (C₁-C₆)alkyl, aryl or substituted aryl; b and d are each an integer of 0 to 2; c is an integer from 1 to 6; and h, h1, h2 and k are independently an integer from 1 to 6.

Also provided by the present invention is a method of preparing an organic polysilica film including the steps of: a) reacting a composition including one or more silanes of the formula R¹_{b}(R²O)_{3-b}Si(R³)_{c}Si(OR⁴)_{3-d}R⁵_{d} in the presence of a hydrolysis catalyst; then b) reacting the mixture in the presence of a condensation catalyst to provide an organic polysilica partial condensate; c) disposing the partial condensate on a substrate; and d) curing the partial condensate to form the organic polysilica film; wherein R¹, R², R⁴ and R⁵ are independently selected from hydrogen, (C₁-C₆)alkyl, (C₇-C₁₂)arylalkyl, substituted (C₇-C₁₂)aryl-alkyl, aryl, and substituted aryl; R³ is (C₁-C₁₀)alkylene, —(CH₂)ₕ—, —(CH₂)ₕ₁-Eₖ-(CH₂)ₕ₂—, —(CH₂)ₕ-Z, arylene, substituted arylene, or arylene ether; E is oxygen, NR⁶ or Z; Z is aryl or substituted aryl; R⁶ is hydrogen, (C₁-C₆)alkyl, aryl or substituted aryl; b and d are each an integer of 0 to 2; c is an integer from 1 to 6; and h, h1, h2 and k are independently an integer from 1 to 6.

### DETAILED DESCRIPTION OF THE INVENTION

As used throughout this specification, the following abbreviations shall have the following meanings, unless the context clearly indicates otherwise: ° C.=degrees centigrade; μm=micron=micrometer; mm=millimeter; UV=ultraviolet; rpm=revolutions per minute; min.=minute; hr.=hour; nm=nanometer; g=gram; % wt=% by weight; L=liter; mL=milliliter; ppm=parts per million; GPa=gigaPascals; Mw=weight average molecular weight; and Mn=number average molecular weight.

The term “(meth)acrylic” includes both acrylic and methacrylic and the term “(meth)acrylate” includes both acrylate and methacrylate. Likewise, the term “(meth)acrylamide” refers to both acrylamide and methacrylamide. “Alkyl” includes straight chain, branched and cyclic alkyl groups. The term “polymer” includes both homopolymers and copolymers. The terms “oligomer” and “oligomeric” refer to dimers, trimers, tetramers and the like. “Monomer” refers to any ethylenically or acetylenically unsaturated compound capable of being polymerized. Such monomers may contain one or more double or triple bonds. “Cross-linker” and “cross-linking agent” are used interchangeably throughout this specification and refer to a compound having two or more groups capable of being polymerized. As used herein, the terms “cure” and “curing” refer to polymerization, condensation or any other reaction where the molecular weight of a compound is increased. The step of solvent removal alone is not considered “curing” as used in this specification. However, a step involving both solvent removal and, e.g., polymerization is within the term “curing” as used herein. The term “organic polysilica” material (or organo siloxane) refers to a material including silicon, carbon, oxygen and hydrogen atoms. “Silane” as used herein refers to a silicon-containing material capable of undergoing hydrolysis and/or condensation. The articles “a” and “an” refer to the singular and the plural.

Unless otherwise noted, all amounts are percent by weight and all ratios are by weight. All numerical ranges are inclusive and combinable in any order, except where it is clear that such numerical ranges are constrained to add up to 100%.

The present invention provides an organic polysilica film having a low dielectric constant and improved mechanical properties, such as improved elastic modulus and hardness. The dielectric constant of such films is <4, typically <3 and more typically ≦2.95. Such organic polysilica films are prepared using a partial condensate of one or more silane monomers having a carbon-containing bridging moiety and two or more silicon atoms, wherein each silicon atom contains 1 to 3 hydrolyzable groups. Particularly suitable silane monomers have 5 or 6 hydrolyzable groups. As used herein, the term “partial condensate” refers to a silane oligomer or prepolymer or hydrolyzate that is capable of undergoing further condensation reactions to increase its molecular weight.

Organic polysilica partial condensates are prepared according to the present invention by a method including the steps of: a) reacting a composition including one or more silanes of formula (I) R¹_{b}(R²O)_{3-b}Si(R³)_{c}Si(OR⁴)_{3-d}R⁵_{d} in the presence of a hydrolysis catalyst; and then b) reacting the mixture in the presence of a condensation catalyst; wherein R¹, R², R⁴ and R⁵ are independently selected from hydrogen, (C₁-C₆)alkyl, (C₇-C₁₂)arylalkyl, substituted (C₇-C₁₂)aryl-alkyl, aryl, and substituted aryl; R³ is (C₁-C₁₀)alkylene, —(CH₂)ₕ—, —(CH₂)ₕ₁-Eₖ-(CH₂)ₕ₂—, —(CH₂)ₕ-Z, arylene, substituted arylene, or arylene ether; E is oxygen, NR⁶ or Z; Z is aryl or substituted aryl; R⁶ is hydrogen, (C₁-C₆)alkyl, aryl or substituted aryl; b and d are each an integer of 0 to 2; c is an integer from 1 to 6; and h, h1, h2 and k are independently an integer from 1 to 6.

Organosilanes of formula (I) preferably include those wherein R¹ and R⁵ are independently (C₁-C₄)alkyl, benzyl, hydroxybenzyl, phenethyl or phenyl. Preferably R¹ and R⁵ are methyl, ethyl, tert-butyl, iso-butyl and phenyl. In one embodiment, R³ is (C₁-C₁₀)alkylene, —(CH₂)ₕ—, arylene, arylene ether and —(CH₂)ₕ₁-E-(CH₂)ₕ₂. Exemplary compounds of formula (I) include, but are not limited to, those wherein R³ is methylene, ethylene, propylene, butylene, hexylene, norbornylene, cycloheylene, phenylene, phenylene ether, naphthylene and —CH₂—C₆H₄—CH₂—. In a further embodiment, c is 1 to 4.

Exemplary organosilanes of formula (I) include, but are not limited to, bis(trimethoxysilyl)methane, bis(triethoxysilyl)methane, bis(triphenoxysilyl)methane, bis(dimethoxymethylsilyl)methane, bis(diethoxymethyl-silyl)methane, bis(dimethoxyphenylsilyl)methane, bis(diethoxyphenylsilyl)methane, bis(methoxydimethylsilyl)methane, bis(ethoxydimethylsilyl)methane, bis(methoxy-diphenylsilyl)methane, bis(ethoxydiphenylsilyl)methane, bis(trimethoxysilyl)ethane, bis(triethoxysilyl)ethane, bis(triphenoxysilyl)ethane, bis(dimethoxymethylsilyl)ethane, bis(diethoxymethylsilyl)ethane, bis(dimethoxyphenylsilyl)ethane, bis(diethoxyphenyl-silyl)ethane, bis(methoxydimethylsilyl)ethane, bis(ethoxydimethylsilyl)ethane, bis(methoxy-diphenylsilyl)ethane, bis(ethoxydiphenylsilyl)ethane, 1,3-bis(trimethoxysilyl))propane, 1,3-bis(triethoxysilyl)propane, 1,3-bis(triphenoxysilyl)propane, 1,3-bis(dimethoxy-methylsilyl)propane, 1,3-bis(diethoxymethylsilyl)propane, 1,3-bis(dimethoxyphenyl-silyl)propane, 1,3-bis(diethoxyphenylsilyl)propane, 1,3-bis(methoxydimehylsilyl)propane, 1,3-bis(ethoxydimethylsilyl)propane, 1,3-bis(methoxydiphenylsilyl)propane, and 1,3-bis(ethoxydiphenylsilyl)propane.

In one embodiment, the organic polysilica partial condensate further includes one or more silanes of formula (II) RₐSiY₄₋ₐ, wherein R is hydrogen, (C₁-C₈)alkyl, (C₇-C₁₂)arylalkyl, substituted (C₇-C₁₂)arylalkyl, aryl, and substituted aryl; Y is any hydrolyzable group; and a is an integer from 1 to 2. Each R is independently chosen from (C₁-C₄)alkyl, benzyl, hydroxybenzyl, phenethyl and phenyl, and preferably methyl, ethyl, iso-butyl, tert-butyl and phenyl. Suitable hydrolyzable groups for Y include, but are not limited to, halo, (C₁-C₆)alkoxy, and acyloxy, and preferably chloro and (C₁-C₂)alkoxy. Exemplary organosilanes of formula (II) include, but are not limited to, methyl trimethoxysilane, methyl trichlorosilane, methyl triethoxysilane, phenyl trimethoxysilane, phenyl triethoxysilane, tolyl trimethoxysilane, tolyl triethoxysilane, propyl tripropoxysilane, iso-propyl triethoxysilane, iso-propyl tripropoxysilane, ethyl trimethoxysilane, ethyl triethoxysilane, ethyl trichlorosilane, iso-butyl triethoxysilane, iso-butyl trimethoxysilane, tert-butyl triethoxysilane, tert-butyl trimethoxysilane, cyclohexyl trimethoxysilane, cyclohexyl triethoxysilane, benzyl trimethoxysilane, benzyl triethoxysilane, phenethyl trimethoxysilane, hydroxybenzyl trimethoxysilane, hydroxyphenylethyl trimethoxysilane and hydroxyphenylethyl triethoxysilane.

Suitable organic polysilica materials of the present invention include, but are not limited to, organically modified silicates containing repeating units chosen from O₃SiRSiO₃ and O₂SiR₃SiO₂ wherein R is an organic substituent, and may include silsesquioxanes. Silsesquioxanes are polymeric silicate materials containing a repeating unit of the type RSiO_{1.5} where R is an organic substituent. Suitable silsesquioxanes are alkyl silsesquioxanes such as methylsilsesquioxane; aryl silsesquioxanes; alkyl/aryl silsesquioxane mixtures; and mixtures of alkyl silsesquioxanes.

In an alternate embodiment, the present organic polysilica partial condensates may contain a wide variety of other monomers in addition to the silicon-containing monomers described above. For example, the organic polysilica materials may further include one or more cross-linking agentsIII) and/or carbosilane moieties.

A variety of cross-linking agents may be used. Suitable cross-linking agents are those compounds of formula (III) Mⁿ(OR¹¹)ₙ wherein M is aluminum, titanium, zirconium, silicon, magnesium, or boron; R¹¹ is (C₁-C₆)alkyl, acyl, or Si(OR¹²)₃; R¹² is (C₁-C₆)alkyl or acyl; and n is the valence of M. In one embodiment, R¹¹ is methyl, ethyl, propyl or butyl. In another embodiment, M is aluminum, titanium, zirconium or silicon. It will be appreciated by those skilled in the art that a combination of such second cross-linkers may be used. The ratio of the mixture of silanes of formulae (I) and (II) to such second cross-linking agents is typically from 99:1 to 1:99, preferably from 95:5 to 5:95, more preferably from 90:10 to 10:90.

Carbosilane moieties refer to moieties having a (Si—C)ₓ structure, such as (Si-A)ₓ structures wherein A is a substituted or unsubstituted alkylene or arylene, such as SiR₃CH₂—, —SiR₂CH₂—, ═SiRCH₂—, and ≡SiCH₂—, where R is usually hydrogen but may be any organic or inorganic radical. Suitable inorganic radicals include organosilicon, siloxyl, or silanyl moieties. These carbosilane moieties are typically connected “head-to-tail”, i.e. having Si—C—Si bonds, in such a manner that a complex, branched structure results. Particularly useful carbosilane moieties are those having the repeat units (SiHₓCH₂) and (SiH_{y-1}(CH═CH₂)CH₂), where x=0 to 3 and y=1 to 3. These repeat units may be present in the organic polysilica resins in any number from 1 to 100,000, and preferably from 1 to 10,000. Suitable carbosilane precursors are those disclosed in U.S. Pat. No. 5,153,295 (Whitmarsh et al.) and U.S. Pat. No. 6,395,649 (Wu).

The organic polysilica partial condensates are prepared by a) reacting a composition including one or more silanes of formula (I), typically water, optionally one or more silanes of formula (II), optionally one or more cross-linking agents such as those of formula (III), and optionally one or more carbosilanes with a hydrolysis catalyst for a period of time sufficient to hydrolyze (or partially condense) the silanes; and then b) reacting the hydrolyzed silanes with a condensation catalyst to form a partial condensate having the desired weight average molecular weight. Typically, the reaction temperature of each step a) and b) is from 25° to 100° C. The amount of water is typically from 0.1 to 1.5 mole equivalents, more typically from 0.25 to 1 mole equivalents, and even more typically from 0.5 to 1 mole equivalents. The silanes and water are typically reacted from 0.5 to 48 hours, although longer or shorter times may be used. Particularly suitable reaction times are from 1 to 24 hours. The mole ratios of the silanes may vary over a wide range. The mole ratio of the one or more silanes of formula (I) to the one or more silanes of formula (II) is from 99:1 to 1:99, particularly from 95:5 to 5:95, more particularly from 90:10 to 10:90, and still more particularly from 80:20 to 20:80.

The silane-containing composition may further include one or more organic solvents. A wide variety of organic solvents may suitably be used. Exemplary organic solvents include, but are not limited to, alcohols including polyols, esters including glycol esters, ketones, carbonates, lactones and mixtures thereof.

The one or more silanes of formulae (I) and optionally any other silanes, such as one or more silanes of formula (II), are hydrolyzed in the presence of a first catalyst and then condensed in the presence of a second catalyst to produce the organic polysilica partial condensates. The first catalyst is a hydrolysis catalyst, such as a weak acid catalyst and a weak base catalyst. By “weak acid” its meant an acid having a pKa of ≧2. By “weak base” it is meant any base having a pKb of 3 to 13. Typically, the pKb is from 3 to 10, and more typically from 4 to 7. A weak base is typically a neutral compound containing a non-bonding pair of electrons that can form a bond with a proton or an inorganic salt with anion of a weak acid (i.e., can function as an acceptor of a proton). A wide variety of weak base catalysts may be used, such as, but not limited to, ammonia, amines including primary, secondary and tertiary amines, carbonates such as potassium carbonate, and amides. Exemplary weak base catalysts include, without limitation, cyclohexylamine, dicyclohexylamine, and triethylamine. In one embodiment, it is preferred that the hydrolysis catalyst is a weak base catalyst. The second catalyst is a condensation catalyst. Such condensation catalyst may be either an acid or a base and is typically an acid stronger than a weak acid hydrolysis catalyst or a base stronger than a weak base hydrolysis catalyst. In one embodiement, the condensation catalyst is a strong acid. Suitable strong acid condensation catalysts are those having a pKa of ≦2. Exemplary strong acid condensation catalysts include, without limitation, mineral acids such as hydrochloric acid, nitric acid, sulfuric acid, formic acid, and halogenated organic acids such as trifluoroacetic acid, methanesulfonic acid and trifluoromethanesulfonic acid. Bases that are stronger than the weak base catalyst used in the hydrolysis step may suitably be used as the condensation catalyst. In one embodiment, the base condensation catalyst has a pKb of ≦3. In another embodiment, the base condensation catalyst is a strong base. Exemplary base condensation catalysts include tetraalkylammonium hydroxides such as tetramethylammonium hydroxide. By “strong” acids and bases are meant acids and bases that dissociate completely in aqueous solutions. It will be appreciated that one or more hydrolysis catalysts may be used and/or one or more condensation catalysts may be used in the reaction to form the organic polysilica partial condensates. Alternatively, the silanes of formulae (I) and (II) may be contacted with base and acid catalysts concurrently, such as by the use of a mixed bed ion exchange resin, provided that the base is a weak base ion exchange resin.

The hydrolysis and condensation catalysts may each be independently used in a wide range of amounts. For example, each catalyst may be present in an amount of from 0.1 to 2000 ppm, and preferably from 1 to 1000 ppm. When mineral acids are used as the condensation catalyst, they are typically used in an amount of 1 to 100 ppm and preferably from 1 to 25 ppm.

Typically, the silanes are first contacted with the hydrolysis catalyst, typically a weak base catalyst, and then contacted with the condensation catalyst. The hydrolysis catalyst may optionally be removed from the reaction prior to contact with the condensation catalyst. In one embodiment, the hydrolysis catalyst is removed prior to the step of contacting the mixture with the condensation catalyst. Such removal may be achieved by a variety of means such as, but not limited to, the use of ion exchange resins such as strong acid ion exchange resins (such as those sold by Rohm and Haas Company under the trademarks AMBERLITE IRN-77 and AMBERLYST 15), strong acid/strong base mixed-bed ion exchange resins (such as IRN-150 available from Rohm and Haas Company), weak acid ion exchange resins (such as AMBERLITE IRC-748 and AMBERLITE IRC-50, also available from Rohm and Haas Company), and chelating mixed-bed ion exchange resins. In one embodiment, the hydrolysis catalyst is a weak base and the condensation catalyst is a base stronger than the weak base and preferably is a strong base. In another embodiment, the hydrolysis catalyst is a weak acid and the condensation catalyst is an acid stronger than the weak acid and preferably is a strong acid. In a further embodiment, the hydrolysis catalyst is a weak base and the condensation catalyst is a strong acid. When the hydrolysis catalyst is a weak base and the condensation catalyst is a strong base, the weak base does not need to be removed prior to contact with the condensation catalyst. Likewise, when the hydrolysis catalyst is a weak acid and the condensation catalyst is a strong acid, the weak acid does not need to be removed prior to contact with the condensation catalyst.

Optionally, the condensation catalyst is removed from the reaction mixture following formation of the desired partial condensate. Preferably, the condensation catalyst is removed. A problem with the condensation catalyst remaining is that it may cause further condensation of the partial condensate. Such condensation catalysts may be removed by a variety of processes, including, without limitation, in the case of an acid catalyst contacting the partial condensate with a weak amine ion exchange resin (such as those sold by Rohm and Haas Company under the trademark IRA-67), chelating mixed-bed ion exchange reins (such as those described in U.S. Pat. No. 5,702,611), basic alumina, and basic clays. When a base condensation catalyst is used, it may be removed by a variety of processes including, but not limited to, contacting the partial condensate with a weal acid ion exchange resin. Ion exchange resins are typically conditioned prior to use and such conditioning is well known to those skilled in the art.

In general, the silanes are not significantly further hydrolyzed or condensed by the ion exchange resins used to remove the first and/or second catalysts. Typically, the contact times of the silanes with such catalyst removal ion exchange resins are selected such that they are not sufficient to provide significant hydrolysis or condensation of the silanes. Also, such ion exchange catalyst removal step is typically performed at a temperature below the reflux temperature of the silane mixture, and typically performed at 20° to 25° C.

The present organic polysilica partial condensates may have a wide range of molecular weights. Typically, the partial condensates have a weight average molecular weight of ≦20,000, although higher molecular weights may be used. More typically, the weight average molecular weight is ≦15,000, still more typically ≦10,000, and most typically ≦7,000.

Following formation of the organic polysilica partial condensates, and after optionally removing the condensation catalyst, a stabilizing agent may be optionally added to the partial condensates. Such stabilizing agents are preferably organic acids. Any organic acid having at least 2 carbons and having an acid dissociation constant (“pKa”) of about 1 to about 4 at 25° C. is suitable. Preferred organic acids have a pKa of about 1.1 to about 3.9, and more preferably about 1.2 to about 3.5. Organic acids capable of functioning as chelating agents are preferred. Such chelating organic acids include polycarboxylic acids such as di-, tri-, tetra- and higher carboxylic acids, and carboxylic acids substituted with one or more of hydroxyls, ethers, ketones, aldehydes, amine, amides, imines, thiols and the like. Preferred chelating organic acids are polycarboxylic acids and hydroxy-substituted carboxylic acids. The term “hydroxy-substituted carboxylic acids” includes hydroxy-substituted polycarboxylic acids. Suitable organic acids include, but are not limited to: oxalic acid, malonic acid, methylmalonic acid, dimethylmalonic acid, maleic acid, malic acid, citramalic acid, tartaric acid, phthalic acid, citric acid, glutaric acid, glycolic acid, lactic acid, pyruvic acid, oxalacetic acid, α-ketoglutaric acid, salicylic acid and acetoacetic acid. Preferred organic acids are oxalic acid, malonic acid, dimethylmalonic acid, citric acid and lactic acid, and more preferably malonic acid. Mixtures of organic acids may be advantageously used in the present invention. Those skilled in the art will realize that polycarboxylic acids have a pKa value for each carboxylic acid moiety in the compound. Only one of the pKa values in such polycarboxylic acids needs to be within the range of 1 to 4 at 25° C. for the organic acid to be suitable for use in the present invention. Such stabilizing agents are typically used in an amount of 1 to 10,000 ppm and preferably from 10 to 1000 ppm. Such stabilizing agents function to retard further condensation of the material and extend the shelf-life of the partial condensates.

The present organic polysilica partial condensates are useful for forming organic polysilica films. Such organic polysilica films are particularly useful as dielectrics in electronic and optoelectronic devices. Such films may be formed by disposing a composition including an organic polysilica partial condensate on a substrate and then curing the partial condensate to form an organic polysilica film.

Particularly suitable substrates are those useful in the manufacture of electronic and optoelectronic devices. Suitable electronic devices include, but are not limited to, interconnect structures, semiconductors, semiconductor packaging, printed wiring boards, and the like. Particular electronic device substrates include, but are not limited to: silicon, silicon on insulator, silicon germanium, silicon dioxide, glass, silicon nitride, ceramics, aluminum, copper, gallium arsenide, plastics, such as polycarbonate, circuit boards, such as FR-4 and polyimide, and hybrid circuit substrates, such as aluminum nitride-alumina. Such substrates may further include thin films deposited thereon, such films including, but not limited to: metal nitrides, metal carbides, metal silicides, metal oxides, and mixtures thereof. In a multilayer integrated circuit device, an underlying layer of insulated, planarized circuit lines can also function as a substrate.

The term “optoelectronic devices” as used herein is also intended to include photonic devices. Suitable optoelectronic devices include, without limitation, waveguides, splitters, array waveguides, couplers, spectral filters, polarizers, isolators, wavelength division multiplexing structures, optical switches, diffraction gratings, interconnects, attenuators, amplifiers, and the like. The present compositions and films therefrom are also suitable for use in antireflectant coatings, scratch resistant coatings, and the like.

Any suitable means may be used to dispose the organic polysilica partial condensates on a substrate, such as dip coating, spin coating, roll coating, curtain coating, spray coating, vapor deposition techniques, such as chemical vapor deposition, and the like.

Typically, the partial condensates are disposed on the substrate as a composition including one or more solvents. Suitable solvents are any which dissolve or disperse the partial condensates and include, but are not limited to, ketones such as methyl isobutyl ketone, diisobutyl ketone, cyclohexanone, and 2-heptanone, lactones such as γ-butyrolactone and ε-caprolactone, esters such as ethyl lactate, n-amyl acetate, n-butyl acetate, and propyleneglycol monomethyl ether acetate, ethers such as propyleneglycol monomethyl ether, diphenyl ether and anisole, nitrogen-containing solvents such as N-methyl-2-pyrrolidone and N,N′-dimethylpropyleneurea, aromatic hydrocarbons such as mesitylene and xylenes, or mixtures thereof.

After being deposited on a substrate, the organic polysilica partial condensate is then substantially cured to form a rigid, cross-linked organic polysilica material. The curing of the organic polysilica material may be by any means known in the art including, but not limited to, heating, exposure to actinic radiation such as UV and e-beam irradiation and combinations thereof, such as a combination of heating and exposure to actinic radiation. Typically, the partial condensate is cured by heating at an elevated temperature, e.g. either directly such as heating at a constant temperature such as on a hot plate, or in a step-wise manner. Typically, the organic polysilica material is heated at a temperature of from 100° to 450° C.

Organic polysilica films produced from the present dual catalyst prepared organic polysilica partial condensates have improved elastic modulus and hardness as compared to the same organic polysilica films prepared using a single, either acid or base, catalyst. Such organic polysilica films also have lower dielectric constants as compared to films prepared from conventionally catalyzed partial condensates, particularly conventional acid catalyzed partial condensates. Such reduced dielectric constants allow for the use of lesser amounts of porogens in order to achieve the same low dielectric constant value as compared to conventional organic polysilica films. The present organic polysilica partial condensates also have improved coating quality and uniformity as compared to conventional organic polysilica partial condensates.

It will be appreciated that a mixture of dielectric materials including the present organic polysilica partial condensates may be used, such as two or more organic polysilica partial condensates or a mixture of an organic polysilica partial condensates with one or more other dielectric materials, i.e. not an organic polysilica dielectric material. Suitable other dielectric materials include, but are not limited to, inorganic matrix materials such as carbides, oxides, nitrides and oxyfluorides of silicon, boron, or aluminum; and organic matrix materials such as benzocyclobutenes, poly(aryl esters), poly(ether ketones), polycarbonates, polyimides, fluorinated polyimides, polynorbornenes, poly(arylene ethers), polyaromatic hydrocarbons, such as polynaphthalene, polyquinoxalines, poly(perfluorinated hydrocarbons) such as poly(tetrafluoroethylene), and polybenzoxazoles.

In an alternate embodiment, the present partial condensates may be used to form porous organic polysilica films. In this embodiment, a composition including an organic polysilica partial condensate, a porogen and optionally a solvent is disposed on a substrate. The term “porogen” refers to a pore forming material that is dissolved or dispersed in an layer of the organic polysilica material and that is removed to form pores or voids in the organic polysilica material. The porogens may be solvents, polymers such as linear polymers, uncross-linked polymers or polymeric particles, monomers or polymers that are co-polymerized with the organic polysilica material to form a block copolymer having a labile (removable) component. In an alternative embodiment, the porogen may be pre-polymerized with the organic polysilica material prior to being disposed on the substrate. Any of the above described solvents may be employed these compositions. Any of the above described disposing means may also be used to dispose any of these porogen containing compositions on a substrate.

Preferably, the porogen is substantially non-aggregated or non-agglomerated in the partial condensate material. Such non-aggregation or non-agglomeration reduces or avoids the problem of killer pore or channel formation in the organic polysilica material. It is preferred that the removable porogen is a porogen particle or is co-polymerized with the organic polysilica partial condensate, and more preferably a porogen particle. It is further preferred that the porogen particle is substantially compatible with the organic polysilica partial condensate. By “substantially compatible” is meant that a composition of organic polysilica partial condensate and porogen is slightly cloudy or slightly opaque. Preferably, “substantially compatible” means at least one of a solution of organic polysilica partial condensate and porogen, a film or layer including a composition of organic polysilica partial condensate and porogen, a composition including an organic polysilica partial condensate having porogen dispersed therein, and the resulting porous organic polysilica material after removal of the porogen is slightly cloudy or slightly opaque. To be compatible, the porogen must be soluble or miscible in the organic polysilica partial condensate, in the solvent used to dissolve the partial condensate or both. Suitable compatibilized porogens are those disclosed in U.S. Pat. No. 6,271,273 (You et al.) and U.S. Pat. No. 6,420,441 (Allen et al.). Other suitable removable particles are those disclosed in U.S. Pat. No. 5,700,844.

Substantially compatibilized porogens are preferably polymer particles. These particles typically have a molecular weight in the range of 10,000 to 1,000,000, preferably 20,000 to 500,000, and more preferably 20,000 to 100,000. The particle size polydispersity of these materials is in the range of 1 to 20, preferably 1.001 to 15, and more preferably 1.001 to 10. It is preferred that such substantially compatibilized porogens are cross-linked. Typically, the amount of cross-linking agent is at least 1% by weight, based on the weight of the porogen. Up to and including 100% cross-linking agent, based on the weight of the porogen, may be effectively used in the particles of the present invention. It is preferred that the amount of cross-linker is from 1% to 80%, and more preferably from 1% to 60%.

Porogen particles may be composed of a variety of monomers, such as, but not limited to, one or more of silyl containing monomers, poly(alkylene oxide)monomers, (meth)acrylic acid, (meth)acrylamides, alkyl(meth)acrylates, alkenyl(meth)acrylates, aromatic(meth)acrylates, vinyl aromatic monomers, nitrogen-containing compounds and their thio-analogs, substituted ethylene monomers, and combinations thereof.

Particularly useful compatibilized porogens are those containing as polymerized units at least one compound selected from silyl containing monomers or poly(alkylene oxide)monomers and one or more cross-linking agents. Such porogens are described in U.S. Pat. No. 6,271,273. Suitable silyl containing monomers include, but are not limited to, vinyltrimethylsilane, vinyltriethylsilane, vinyltrimethoxysilane, vinyltriethoxysilane, γ-trimethoxysilylpropyl(meth)acrylate, divinylsilane, trivinylsilane, dimethyldivinylsilane, divinylmethylsilane, methyltrivinylsilane, diphenyldivinylsilane, divinylphenylsilane, trivinylphenylsilane, divinylmethylphenylsilane, tetravinylsilane, dimethylvinyldisiloxane, poly(methylvinylsiloxane), poly(vinylhydrosiloxane), poly(phenylvinylsiloxane), allyloxy-tert-butyldimethylsilane, allyloxytrimethylsilane, allyltriethoxysilane, allyltri-iso-propylsilane, allyltrimethoxysilane, allyltrimethylsilane, allyltriphenylsilane, diethoxy methylvinylsilane, diethyl methylvinylsilane, dimethyl ethoxyvinylsilane, dimethyl phenylvinylsilane, ethoxy diphenylvinylsilane, methyl bis(trimethylsilyloxy)vinylsilane, triacetoxyvinylsilane, triethoxyvinylsilane, triethylvinylsilane, triphenylvinylsilane, tris(trimethylsilyloxy)vinylsilane, vinyloxytrimethylsilane and mixtures thereof. The amount of siliyl containing monomer useful to form the porogens of the present invention is typically from 1 to 99% wt, based on the total weight of the monomers used. It is preferred that the silyl containing monomers are present in an amount of from 1 to 80% wt, and more preferably from 5 to 75% wt.

Suitable poly(alkylene oxide)monomers include, but are not limited to, poly(propylene oxide)monomers, poly(ethylene oxide)monomers, poly(ethylene oxide/propylene oxide)monomers, poly(propylene glycol)(meth)acrylates, poly(propylene glycol)alkyl ether(meth)acrylates, poly(propylene glycol)phenyl ether(meth)acrylates, poly(propylene glycol) 4-nonylphenol ether(meth)acrylates, poly(ethylene glycol)(meth)acrylates, poly(ethylene glycol)alkyl ether(meth)acrylates, poly(ethylene glycol)phenyl ether(meth)acrylates, poly(propylene/ethylene glycol)alkyl ether(meth)acrylates and mixtures thereof. Preferred poly(alkylene oxide)monomers include trimethoylolpropane ethoxylate tri(meth)acrylate, trimethoylolpropane propoxylate tri(meth)acrylate, poly(propylene glycol)methyl ether acrylate, and the like. Particularly suitable poly(propylene glycol) methyl ether acrylate monomers are those having a molecular weight in the range of from 200 to 2000. The poly(ethylene oxide/propylene oxide)monomers useful in the present invention may be linear, block or graft copolymers. Such monomers typically have a degree of polymerization of from 1 to 50, and preferably from 2 to 50. Typically, the amount of poly(alkylene oxide) monomers useful in the porogens of the present invention is from 1 to 99% wt, based on the total weight of the monomers used. The amount of poly(alkylene oxide)monomers is preferably from 2 to 90% wt, and more preferably from 5 to 80% wt.

The silyl containing monomers and the poly(alkylene oxide)monomers may be used either alone or in combination to form the porogens of the present invention. In general, the amount of the silyl containing monomers or the poly(alkylene oxide)monomers needed to compatibilize the porogen with the dielectric matrix depends upon the level of porogen loading desired in the matrix, the particular composition of the organic polysilica dielectric matrix, and the composition of the porogen polymer. When a combination of silyl containing monomers and the poly(alkylene oxide)monomers is used, the amount of one monomer may be decreased as the amount of the other monomer is increased. Thus, as the amount of the silyl containing monomer is increased in the combination, the amount of the poly(alkylene oxide)monomer in the combination may be decreased.

Exemplary porogen cross-linkers include, but are not limited to: trivinylbenzene, divinyltoluene, divinylpyridine, divinylnaphthalene and divinylxylene; and such as ethyleneglycol diacrylate, trimethylolpropane triacrylate, diethyleneglycol divinyl ether, trivinylcyclohexane, allyl methacrylate, ethyleneglycol dimethacrylate, diethyleneglycol dimethacrylate, propyleneglycol dimethacrylate, propyleneglycol diacrylate, trimethylolpropane trimethacrylate, divinyl benzene, glycidyl methacrylate, 2,2-dimethylpropane 1,3 diacrylate, 1,3-butylene glycol diacrylate, 1,3-butylene glycol dimethacrylate, 1,4-butanediol diacrylate, diethylene glycol diacrylate, diethylene glycol dimethacrylate, 1,6-hexanediol diacrylate, 1,6-hexanediol dimethacrylate, tripropylene glycol diacrylate, triethylene glycol dimethacrylate, tetraethylene glycol diacrylate, polyethylene glycol 200 diacrylate, tetraethylene glycol dimethacrylate, polyethylene glycol dimethacrylate, ethoxylated bisphenol A diacrylate, ethoxylated bisphenol A dimethacrylate, polyethylene glycol 600 dimethacrylate, poly(butanediol)diacrylate, pentaerythritol triacrylate, trimethylolpropane triethoxy triacrylate, glyceryl propoxy triacrylate, pentaerythritol tetraacrylate, pentaerythritol tetramethacrylate, dipentaerythritol monohydroxypentaacrylate, and mixtures thereof. Silyl containing monomers that are capable of undergoing cross-linking may also be used as cross-linkers, such as, but not limited to, divinylsilane, trivinylsilane, dimethyldivinylsilane, divinylmethylsilane, methyltrivinylsilane, diphenyldivinylsilane, divinylphenylsilane, trivinylphenylsilane, divinylmethylphenylsilane, tetravinylsilane, dimethylvinyldisiloxane, poly(methylvinylsiloxane), poly(vinylhydrosiloxane), poly(phenylvinylsiloxane), tetraallylsilane, 1,3-dimethyl tetravinyldisiloxane, 1,3-divinyl tetramethyldisiloxane and mixtures thereof.

Suitable block copolymers having labile components useful as removable porogens are those disclosed in U.S. Pat. Nos. 5,776,990 and 6,093,636. Such block copolymers may be prepared, for example, by using as pore forming material highly branched aliphatic esters that have functional groups that are further functionalized with appropriate reactive groups such that the functionalized aliphatic esters are incorporated into, i.e. copolymerized with, the vitrifying polymer matrix. Such block copolymers are suitable for forming porous organic polysilica materials, such as benzocyclobutenes, poly(aryl esters), poly(ether ketones), polycarbonates, polynorbornenes, poly(arylene ethers), polyaromatic hydrocarbons, such as polynaphthalene, polyquinoxalines, poly(perfluorinated hydrocarbons) such as poly(tetrafluoroethylene), polyimides, polybenzoxazoles and polycycloolefins.

To be useful in forming porous organic polysilica materials, the porogens of the present invention must be at least partially removable under conditions which do not adversely affect the organic polysilica material, preferably substantially removable, and more preferably completely removable. By “removable” is meant that the porogen degrades, depolymerizes or otherwise breaks down into volatile components or fragments which are then removed from, or migrate out of, the organic polysilica material yielding pores or voids. Any procedures or conditions which at least partially remove the porogen without adversely affecting the organic polysilica material may be used. It is preferred that the porogen is substantially removed. Typical methods of removal include, but are not limited to: exposure to heat, pressure, vacuum or radiation such as, but not limited to, actinic, IR, microwave, UV, x-ray, gamma ray, alpha particles, neutron beam, electron beam, dissolution, chemical etching and the like. It will be appreciated that more than one method of removing the porogen or polymer may be used, such as a combination of heat and actinic radiation. It is preferred that the organic polysilica material is exposed to heat, UV light or a combination of heat and UV light to remove the porogen. It will also be appreciated by those skilled in the art that other methods of porogen removal, such as by atom abstraction, may be employed.

The porogens can be thermally removed under vacuum, nitrogen, argon, mixtures of nitrogen and hydrogen, such as forming gas, or other inert or reducing atmosphere. The porogens may be removed at any temperature that is higher than the thermal curing temperature and lower than the thermal decomposition temperature of the dielectric matrix material. Typically, the porogens may be removed at temperatures in the range of 150° to 450° C. and preferably in the range of 250° to 425° C. Typically, the porogens are removed upon heating for a period of time in the range of 1 to 120 minutes. After removal from the dielectric matrix material, 0 to 20% by weight of the porogen typically remains in the porous organic polysilica material.

In one embodiment, when a porogen of the present invention is removed by exposure to radiation, the porogen polymer is typically exposed under an inert atmosphere, such as nitrogen, to a radiation source, such as, but not limited to, visible or ultraviolet light. The energy flux of the radiation must be sufficiently high such that porogen particles are at least partially removed.

The removable porogens are typically added to the organic polysilica partial condensates of the present invention in an amount sufficient to provide the desired lowering of the dielectric constant of the resulting film. For example, the porogens may be added to the partial condensate in any amount of from 1 to 90 wt %, based on the weight of the partial condensate, preferably from 10 to 80 wt %, more preferably from 15 to 60 wt %, and even more preferably from 20 to 30 wt %.

When the porogens are not components of a block copolymer, they may be combined with the organic polysilica partial condensate by any methods known in the art. Typically, the partial condensate is first dissolved or dispersed in a suitable solvent, such as those described above. The porogens are then dispersed or dissolved within the solution. The resulting composition (e.g. dispersion, suspension or solution) is then deposited on a substrate by any of the methods described above to form a film or layer.

After being deposited on a substrate, the partial condensate material is then at least partially cured, and preferably substantially cured, to form a rigid, cross-linked organic polysilica material, as described above, without substantially removing the porogen. After such at least partial curing, the porogen is removed by any of the means described above to form a porous organic polysilica material.

The following examples are expected to further illustrate various aspects of the present invention, but are not intended to limit the scope of the invention in any aspect.

### EXAMPLE 1

A 1 L 3 neck round bottom flask equipped with a thermometer, condenser, nitrogen inlet, and magnetic stirrer was charged with 300 g of 200 proof EtOH, 110.2 g of deionized (DI) H₂O and 0.64 g (6.3 mmol) of triethylamine (TEA). The mixture was stirred under nitrogen for 5 min. 178.3 g (1.00 mol) of methyltriethoxysilane (MTES) and 184.4 g (0.52 mol) of 1,2-bis(triethoxysily)ethane (BESE) were premixed and charged to the flask. After stirring at room temperature (19° C.) for 1 hr., the reaction mixture was refluxed for 1 hr. It was then cooled to room temperature and 50 g of IRN-77 ion exchange resin was charged, stirred for 1 hr. then filtered to remove the ion exchange resin. The mixture was then charged with 8 ppm of HCl and heated to reflux for 1 hr. Next, 50 g of IRA-67 was charged and stirred for 1 hr. to remove the acid catalyst. 300 g of electronic grade propylene glycol methyl ether acetate was added to the reaction mixture. EtOH and H₂O were removed under reduced pressure at 25° C. The mixture was further dried in vacuuo (˜4 mm Hg at 25° C.) for an additional 1 hr. to remove any remaining water and ethanol. 1000 ppm of malonic acid was then charged to stabilize the partial condensate.

The resulting partial condensate had percent solids of 27.6%, an Mw of 3,174, and an Mn of 1,624. Analysis by ¹H NMR indicated 26% SiOH content and 5% SiOEt content (relative to total SiOEt content of MTES and BESE starting material). Analysis by ²⁹Si NMR indicated a T₁ content of 40%, a T₂ content of 50% and a T₃ content of 10%. “T₁” refers to a structure having the unit RSi(OR¹)₂O—Si, where R¹ is hydrogen or an alkyl group. “T₂” refers to a structure having the unit RSi(OR¹)(O—Si)₂ and “T₃” refers to s structure having the unit RSi(OSi)₃.

### EXAMPLE 2

The procedure of Example 1 was repeated except that the base catalyzed hydrolysis step was perfomed at 50° C. for 3 hr. with stirring, and no HCl was added, the reaction mixture was acidified with IRN-77 then stirred at 25° C. for 1 hr. The resulting partial condensate had an Mw of 7513.

### COMPARATIVE EXAMPLE 1

A 1 L 3-neck round bottom flask equipped with a thermometer, condenser, nitrogen inlet, and magnetic stirrer was charged with 50.8 g (0.28 mol) of MTES, 52.0 g (0.15 mol) of BESE, 85 g of electronics grade PGMEA and 30 g of 200 Proof EtOH. While stirring under N₂, 31.2 g (1.7 mol) of DI water was added followed by 0.57 g of 0.0959 N HCl (8 ppm of HCl in total reaction mixture). After stirring at room temperature (19° C.) for 1 hr., the reaction mixture was refluxed for 1 hr. It was then cooled to room temperature. 20 g of IRA-67 ion exchange resin was charged and stirred for 1 hr. to remove HCl. The reaction mixture was then transferred to a 1 L round bottom flask. EtOH and H₂O were removed under reduced pressure (rotary evaporator) at 25° C. for about 1 hr. The reaction mixture was then pumped on (˜4 mm Hg at 25° C.) for an additional 2 hr. to remove any additional water and ethanol. The polymer solution was then batch ion exchanged to remove metals. The resulting polymer had percent solids of 32.8%, an Mw of 4,132, an Mn of 2,196.

### COMPARATIVE EXAMPLE 2

The procedure of Example 1 was repeated, except that no acid catalyzed condensation was performed after base catalyzed hydrolysis. The resulting partial condensate had an Mw of 1627 and Mn of 1,381.

### EXAMPLE 3

Samples of the partial condensates from Examples 1 and 2 and Comparative Example 2 were spun on silicon wafers at 2500 rpm to form films of approximately 1 μm in thickness. The films were baked at 150° C. for 1 minute before further cured at 450° C. for 1 hr. under N₂ and evaluated for coat quality by visual inspection. Coated films of the partial condensates of Examples 1 and 2 were found to have excellent coat quality, while a film of the partial condensate of Comparative Example 2 was found to have a poor coat quality. Accordingly, partial condensates prepared by the present dual catalyst method provided better coatings than partial condensates prepared by conventional base catalysis.

### EXAMPLE 4

Samples of partial condensates from Example 2 and Comparative Example 1 were spun on a silicon wafer to form films of approximately 1 μm in thickness. The films were baked at 450° C. for 1 hr. The mechanical properties of the cured films were then evaluated. The elastic modulus of each film was measured using a HYSITRON nanoindenter to generate indentations in the film while simultaneously measuring the force and displacement. Young's modulus was derived from the nanoindentation data using standard procedures and software. The data are reported in the table below.

| Partial Condensate | Elastic Modulus (GPa) | Hardness (GPa) |
|---|---|---|
| Example 2 | 13.5 | 2.0 |
| Comparative Example 1 | 10.1 | 1.4 |

These data clearly show the improved elastic modulus and hardness provided by the present dual catalyzed organic polysilica partial condensates. Such higher elastic modulus and hardness values indicate improved mechanical properties of the film.

### EXAMPLE 5

Samples were prepared by combining a plurality of cross-linked polymeric particles as porogens with the partial condensates of Example 2 and Comparative Example 1. The polymeric particles included as polymerized units methoxy-polypropyleneoxide/trimethylolpropane trimethacrylate (90/10). Each sample contained 27% wt of the porogens. Each sample was spin coated on a wafer at 2500 rpm, soft baked at 150° C. for 1 minute and then cured at 450° C. for 1 hr. under N₂. The porogens were thermally decomposed during the curing step to form porous films.

The resulting porous films were evaluated for their dielectric (k value) and mechanical properties. The mechanical properties (elastic modulus and hardness) were measured using an MTS nanoindenter following the manufacturer's standard procedures. These results are reported in the following table.

| | | Elastic | |
|---|---|---|---|
| Partial Condensate | K Value | Modulus (GPa) | Hardness (GPa) |
| Example 2 | 2.28 | 3.8 | 0.53 |
| Comparative Example 1 | 2.35 | 3.4 | 0.50 |

The above data clearly demonstrate the improved dielectric and mechanical properties provided by the present organic polysilica partial condensates as compared to those prepared by conventional catalysis methods.

### COMPARATIVE EXAMPLE 3

A 1 L 3-neck round bottom flask equipped with a thermometer, condenser, nitrogen inlet, and magnetic stirrer was charged with 190 g of 200 proof EtOH, 41.8 g of DI H2O and 0.13 g (0.13 mmol) of TEA. The mixture was stirred under nitrogen for 5 min. 64.0 g (0.36 mol) of MTES and 64.0 g (0.31 mol) of TEOS were premixed and charged to the flask. After stirring at room temperature (19° C.) for 1 hr., the reaction mixture was refluxed for 1 hr. It was then cooled to room temperature and 30 g of IRN-77 ion exchange resin was charged, stirred for 1 hr. then filtered to remove TEA. The mixture was then charged with 8 ppm of HCl and heated to reflux for 1 hr. 50 g of IRA-67 was charged and stirred for 1 hr. to remove the acid catalyst. 200 g of Electronic Grade PGMEA was added to the reaction mixture. EtOH and H₂O were removed under reduced pressure at 25° C. The mixture was further dried in vacuuo (˜4 mm Hg at 25° C.) for an additional 1 hr. to remove any additional water and ethanol. Malonic acid (1000 ppm) was then charged to stabilize the partial condensate solution. The resulting partial condensate had percent solids of 15.5%, an Mw of 2,220, and an Mn of 1,468.

### COMPARATIVE EXAMPLE 4

A 1 L 3-neck round bottom flask equipped with a thermometer, condenser, nitrogen inlet, and magnetic stirrer was charged with 120 g of PGMEA, 41.8 g of DI H₂O, 40 g of EtOH, and 0.56 g of 0.0959 N HCl water solution. After stirring for 5 min., 64.0 g (0.36 mol) of MTES and 64.0 g (0.31 mol) of TEOS were mixed and charged to the flask. The catalyst concentration was about 8 ppm. The cloudy mixture became clear in 30 min. and was stirred for additional 30 min. Then it was heated to 78° C. and held at 78°-82° C. for 1 hr. After cooling to room temperature, the reaction mixture was charged 10:1 on a weight basis (polymer solution to ion exchange resin) with conditioned IRA-67 resin in a Nalgene HDPE bottle. The resulting slurry was agitated using a roller for 1 hr. The IRA-67 IX resin was removed by filtration. 80 g of PGMEA was then added. EtOH and H₂O were removed under reduced pressure (rotary evaporator) at 25° C. for about 1 hr. The reaction mixture was then dried in vacuuo (˜4 mm Hg at 25° C.) for an additional 1 hr. to remove any additional water and ethanol. The partial condensate solution was then batch ion exchanged to remove metals. The resulting partial condensate had percent solids of 20%, an Mw of 3,500, an Mn of 1,800. The final product was stabilized with 1000 ppm malonic acid.

### COMPARATIVE EXAMPLE 5

Films of the partial condensates of Example 6 and Comparative Example 3 were spin coated on silicon wafers at 2500 rpm to an approximate thickness of 1 μm. The films were then soft baked at 150° C. for 1 minute and then cured at 450° C. for 1 hr. under N₂. The films were then evaluated to determine their dielectric and mechanical properties following the procedures of Example 5. These data are presented in the following table.

| | | | |
|---|---|---|---|
| | | Elastic | |
| Partial Condensate | K Value | Modulus (GPa) | Hardness (GPa) |

| | | | |
|---|---|---|---|
| Comparative Example 3 | 2.65 | 7.39 | 0.90 |
| Comparative Example 4 | 2.63 | 7.48 | 0.96 |

From these data, it can be see the benefits of the present dual catalyst cure process are not apparent in organic polysilica partial condensates that do not contain a carbon-containing bridging moiety.

1. A method of preparing an organic polysilica partial condensate including the steps of: a) reacting a composition including one or more silanes of the formula R¹_{b}(R²O)_{3-b}Si(R³)_{c}Si(OR⁴)_{3-d}R⁵_{d} in the presence of a hydrolysis catalyst; and then b) reacting the mixture in the presence of a condensation catalyst; wherein R¹, R², R⁴ and R⁵ are independently selected from hydrogen, (C₁-C₆)alkyl, (C₇-C₁₂)arylalkyl, substituted (C₇-C₁₂)aryl-alkyl, aryl, and substituted aryl; R³ is (C₁-C₁₀)alkylene, —(CH₂)ₕ—, —(CH₂)ₕ₁-Eₖ-(CH₂)ₕ₂—, —(CH₂)ₕ-Z, arylene, substituted arylene, or arylene ether; E is oxygen, NR⁶ or Z; Z is aryl or substituted aryl; R⁶ is hydrogen, (C₁-C₆)alkyl, aryl or substituted aryl; b and d are each an integer of 0 to 2; c is an integer from 1 to 6; and h, h1, h2 and k are independently an integer from 1 to 6.

2. The method of claim 1 wherein wherein R³ is chosen from methylene, ethylene, propylene, butylene, hexylene, norbornylene, cycloheylene, phenylene, phenylene ether, naphthylene and —CH₂—C₆H₄—CH₂—.

3. The method of claim 1 wherein the composition further comprises one or more silanes of the formula
Mⁿ(OR¹¹)ₙ
wherein M is aluminum, titanium, zirconium, silicon, magnesium, or boron; R¹¹ is (C₁-C₆)alkyl, acyl, or Si(OR¹²)₃; R¹² is (C₁-C₆)alkyl or acyl; and n is the valence of M.

4. The method of claim 1 wherein the composition further comprises one or more silanes of the formula
RₐSiY₄₋ₐ
wherein R is hydrogen, (C₁-C₈)alkyl, (C₇-C₁₂)arylalkyl, substituted (C₇-C₁₂)arylalkyl, aryl, and substituted aryl; Y is any hydrolyzable group; and a is an integer from 1 to 2.

5. The method of claim 1 wherein the condensation catalyst is chosen from a strong acid and a strong base.

6. A method of preparing an organic polysilica film including the steps of: a) reacting a composition including one or more silanes of the formula R¹_{b}(R²O)_{3-b}Si(R³)_{c}Si(OR⁴)_{3-d}R⁵_{d} in the presence of a hydrolysis catalyst; then b) reacting the mixture in the presence of a condensation catalyst to provide an organic polysilica partial condensate; c) disposing the partial condensate on a substrate; and d) curing the partial condensate to form the organic polysilica film; wherein R¹, R², R⁴ and R⁵ are independently selected from hydrogen, (C₁-C₆)alkyl, (C₇-C₁₂)arylalkyl, substituted (C₇-C₁₂)aryl-alkyl, aryl, and substituted aryl; R³ is (C₁-C₁₀)alkylene, —(CH₂)ₕ—, —(CH₂)ₕ₁-Eₖ-(CH₂)ₕ₂—, —(CH₂)ₕ-Z, arylene, substituted arylene, or arylene ether; E is oxygen, NR⁶ or Z; Z is aryl or substituted aryl; R⁶ is hydrogen, (C₁-C₆)alkyl, aryl or substituted aryl; b and d are each an integer of 0 to 2; c is an integer from 1 to 6; and h, h1, h2 and k are independently an integer from 1 to 6.

7. The method of claim 6 wherein wherein R³ is chosen from methylene, ethylene, propylene, butylene, hexylene, norbornylene, cycloheylene, phenylene, phenylene ether, naphthylene and —CH₂—C₆H₄—CH₂—.

8. The method of claim 6 wherein the composition further comprises one or more silanes of the formula
Mⁿ(OR¹¹)ₙ
wherein M is aluminum, titanium, zirconium, silicon, magnesium, or boron; R¹¹ is (C₁-C₆)alkyl, acyl, or Si(OR¹²)₃; R¹² is (C₁-C₆)alkyl or acyl; and n is the valence of M.

9. The method of claim 6 wherein the composition further comprises one or more silanes of the formula
RₐSiY₄₋ₐ
wherein R is hydrogen, (C₁-C₈)alkyl, (C₇-C₁₂)arylalkyl, substituted (C₇-C₁₂)arylalkyl, aryl, and substituted aryl; Y is any hydrolyzable group; and a is an integer from 1 to 2.

10. The method of claim 6 wherein the partial condensate further comprises a porogen.

11. The method of claim 10 wherein the porogen is a plurality of polymeric particles.

12. The method of claim 11 wherein the polymeric particles are cross-linked.
